(19) United States
(12) Patent Application Publication
(10) Pub. No.: US 2009/0314173 A1
(43) Pub. Date: Dec. 24, 2009

(54) Printing plate, method of manufacturing printing plate, apparatus for manufacturing printing plate, and priting method

(75) Inventors: Akira Nakamura, Tokyo (JP); Taku Naitou, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: RISO KAGAKU CORPORATION, Tokyo (JP)

(21) Appl. No.: 12/457,712

(22) Filed: Jun. 19, 2009

(30) Foreign Application Priority Data
Jun. 20, 2008 (JP) 2008-162009
Jan. 23, 2009 (JP) 2009-013098

(51) Int. Cl. B41N 1/00; B41F 33/00; B23P 17/00

(52) U.S. Cl. 101/395; 101/483; 29/592

(57) ABSTRACT

It is an object to manufacture a printing plate for an anastatic printing method that performs printing by transferring ink applied to convexities of a printing image to a printing medium. Holes on a surface of a porous sheet having plural three-dimensionally communicated holes are blocked by a coating layer. A printing image composed of concavities and convexities are formed on the sheet by driving a TPH while interposing and carrying the sheet between a TPH3 and a platen roller. Since the concavities are easily formed by fusing and contracting the sheet having open-cell foams by heating, plate-making is simple. Since surfaces of the convexities are covered by the coating layer, ink does not permeate inside even when the ink is applied for printing and it is possible to accurately adjust an amount of ink, thereby achieving a high-quality print matter.

### BACKGROUND OF THE INVENTION

1. Field of the Invention

The present invention relates to an anastatic printing method that prints an image by applying ink onto convexities of a printing plate that make a printing image and then transferring the ink onto a printing medium, a printing plate that is easily manufactured and applied to the method, a method of manufacturing the printing plate, and an apparatus for manufacturing the printing plate.

2. Description of the Related Art

A variety of anastatic printing methods that use a printing image composed of concavity and convexity as a printing plate, apply ink onto the convexities, and transfer the ink by contacting the convexities to a printing medium have been known in the art. In particular, flexography that can be provided for rotary printing by installing a flexible printing plate to a drum has been widely spread, and for example, has been used for printing that uses, as a printing medium, a cardboard, a paper, a plate material, a packing film for packing food and other products, and aluminum foil, etc.

Materials having large flexibility and impact resilience, such as photosensitive resin or rubber, are generally used as a printing plate in the flexography. When a photosensitive resin plate is used, a desired image composed of convexities and concavities is formed by removing unexposed portions after radiating UV rays through a mask, such as negative film. When a rubber plate is used, a desired image composed of convexities and concavities is formed by laser plate-making. An image is printed by installing a printing plate manufactured as described above to a rotary press, transferring ink onto the surface of the convexities of the printing plate using an inking roller, contacting the convexities to a provided printing medium to transfer the ink to the printing medium.

A method of plate-making a printing plate for the flexography is disclosed in JP-A-2002-361820, which provides a method of manufacturing a printing plate without using a negative film or positive film.

A method of plate-making a printing plate for the flexography is disclosed in JP-A-2001-183814, which particularly provides a method that makes it possible to effectively separate and remove non-hardened resin after exposing.

### SUMMARY OF THE INVENTION

Large-scale equipment is required for manufacturing a printing plate for flexography as described above, such that a large cost for installing and maintaining the equipment is required. Further, the manufacturing method itself is complicated and difficult. Therefore, it is rare for users having a printing machine to manufacture a printing plate by himself/herself using his/her own plate-making equipment for flexography, such that they have generally trusted it to other professional manufacturers.

Designed in consideration of the above problems, an object of the present invention is to provide a printing plate, particularly a printing plate that can be easily manufactured, which is used for an anastatic printing method that prints an image by transferring ink applied to convexities of a printing image onto a printing medium.

A printing plate described in claim 1 has a printing image, which has concavities and convexities, on a surface, and performs printing by transferring ink applied to printing surfaces of the convexities onto a printing medium, in which a printing image having concavities and convexities is formed on a surface of a porous sheet having three-dimensionally communicated holes, and at least holes of printing surfaces of the convexities are blocked.

In the printing plate described in claim 2 and according to claim 1, the porous sheet is manufactured by extracting water-soluble hole-forming material and water-soluble polymer compound using water from a formed body of a mixture that is obtained by heating-mixing non-water-soluble thermoplastic resin, water-soluble hole-forming material that is thermally stable at temperature where the thermoplastic resin is melted, and water-soluble polymer compound functions as a lubricant. Further, the holes of the printing surfaces of the convexities are blocked by the coating layer formed on the printing surfaces.

A method described in claim 3 of manufacturing a printing plate that has a printing image, which has concavities and convexities, on a surface, and performs printing by transferring ink applied to printing surfaces of the convexities onto a printing medium, includes: a process of blocking holes formed on the surface of a porous sheet having three-dimensionally communicated holes by forming a coating layer on the surface of the porous sheet; and a process of forming a printing image having convexities and concavities, on the porous sheet, by using at least one operation selected from among operations of heating and impact.

A method described in claim 4 of manufacturing a printing plate that has a printing image, which has concavities and convexities, on a surface, and performs printing by transferring ink applied to printing surfaces of the convexities onto a printing medium, includes: a process of forming a printing image having convexities and concavities, on a surface of a porous sheet having three-dimensionally communicated holes, by using at least one operation selected from among operations of heating and impact; and a process of surface treatment that blocks at least holes of printing surfaces of the convexities of the porous sheet.

A method of manufacturing a printing plate described in claim 5 has a printing image, which has concavities and convexities, on a surface, and performs printing by transferring ink applied to printing surfaces of the convexities onto a printing medium, in which a printing image having convexities and concavities on a surface of a porous sheet having three-dimensionally communicated holes is formed by heating, and at least holes of the printing surfaces of the convexities are blocked.

An apparatus described in claim 6 for manufacturing a printing plate that has a printing image, which has concavities and convexities, on a surface, and performs printing by transferring ink applied to printing surfaces of the convexities onto a printing medium, includes image forming means for forming a printing image having convexities and concavities, on a surface of a porous sheet having three-dimensionally communicated holes, by using at least one operation selected from among operations of heating and impact.

A printing method described in claim 7 performs printing by transferring, on a printing medium, ink applied to printing surfaces of convexities of a printing image having the convexities and concavities, in which by applying a predetermined amount of ink to the printing surface where holes of the convexities, which are formed on a surface of a porous sheet having three-dimensionally communicated holes, are blocked, and bringing the printing surfaces of the convexities into contact with the printing medium, the ink is transferred to the printing medium and the image is formed on the printing medium by the ink.

According to the printing plate described in claim 1, forming the concavities on the surface of the porous sheet is advantageous in manufacturing and the manufacturing is easy, as compared with when forming concavities in a material without open-cell foams (holes) therein. Further, since the ink cannot permeated because at least the holes of the printing surfaces of the convexities, in the concavities and convexities constituting the image formed on the surface of the porous sheet, are blocked, it is possible to accurately control the amount of ink attached to the printing surfaces of the convexities. Therefore, high accuracy can be achieved in printing by transferring the ink on a printing medium and a high-quality image printing can be achieved.

According to the printing plate described in claim 2, in addition to the effect by the printing plate described in claim 1, in particular, since a madreporite body that is easy to form concavities on the surface to form an image can be used as the porous sheet, it is possible to surely and easily achieve a structure for blocking the holes of the convexities by the coating layer.

According to the method of manufacturing a printing plate described in claim 3, since it is possible to block the holes opened on the surface of the porous sheet by forming the coating layer on the surface of the porous sheet and then, to form the convexities by heating, impact, or any one the heating and impact, it is possible to easily form a printing image on the surface of the porous sheet by selecting the ways, such that it is possible to easily manufacture a printing plate using a simple process.

According to the method of manufacturing a printing plate described in claim 4, since it is possible to block at least the holes of the printing surface of the convexities of the porous sheet after forming a printing image on the surface of the porous sheet selectively using the ways from heating, impact, or any one of the heating and impact, it is possible to easily form a printing image on the surface of the porous sheet by selectively using the ways.

According to the method of manufacturing a printing plate described in claim 5, since it is possible to form a printing image having convexities and concavities on the surface of a porous sheet by heating and block at least the holes of the printing surfaces of the convexities, surface treatment is simultaneously finished with the process of forming an image.

According to the apparatus for manufacturing a printing plate described in claim 6, since concavities can be easily formed on the surface of a porous sheet by heating, impact, or any one of the heating and impact, it is easy to form a printing image on the surface of the porous sheet by selectively using the ways and it is possible to manufacture a printing plate.

According to the printing method described in claim 7, since the holes of the surface of convexities where ink is applied is blocked even though three-dimensionally communicated holes is formed therein, by using the porous sheet as a material for the printing plate through which the ink cannot permeate inside, it is possible to apply the ink to the printing surfaces of the convexities while appropriately controlling the amount of ink, transfer the ink to a printing medium using appropriate elastic force, and perform accurate and high-quality printing.

### BRIEF DESCRIPTION OF THE DRAWINGS

FIG. 1 is a cross-sectional view showing a porous sheet that is a material of a printing plate according to a first embodiment of the present invention;

FIG. 2 is a cross-sectional view showing an example of a process of forming a coating layer on the porous sheet according to the first embodiment;

FIG. 3 is a perspective view illustrating a method and an apparatus for manufacturing a printing plate according to the first embodiment;

FIG. 4 is a cross-sectional view illustrating the method and the apparatus for manufacturing the printing plate according to the first embodiment;

FIG. 5 is a perspective view illustrating a modification of the method and the apparatus for manufacturing the printing plate according to the first embodiment;

FIG. 6 is a cross-sectional view illustrating a method for manufacturing a printing plate according to the modification of the first embodiment;

FIG. 7 is a cross-sectional view showing a printing plate manufactured by the modification of the first embodiment;

FIG. 8 is a front view illustrating a method and an apparatus for manufacturing a printing plate according to a second embodiment;

FIG. 9 is a perspective view showing the apparatus for manufacturing the printing plate according to the second embodiment;

FIG. 10 is a cross-sectional view illustrating the method of manufacturing the printing plate according to the second embodiment;

FIG. 11 is a front view illustrating a method and an apparatus for manufacturing a printing plate according to a third embodiment;

FIG. 12 is a perspective view showing the apparatus for manufacturing the printing plate according to the third embodiment; and

FIG. 13 is a cross-sectional view illustrating the method of manufacturing the printing plate according to the third embodiment.

### DETAILED DESCRIPTION OF THE PREFERRED EMBODIMENTS

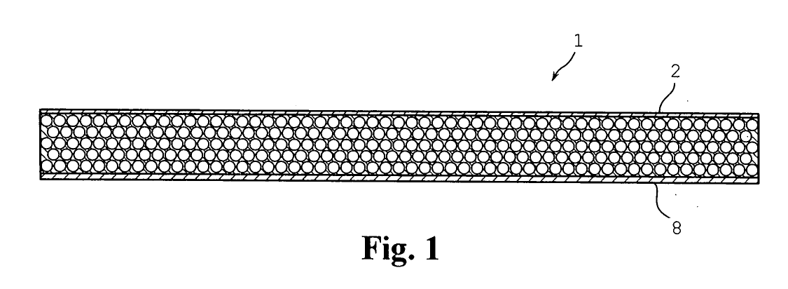

Embodiments of the present invention are described hereafter in detail with reference to FIGS. 1 to 13.

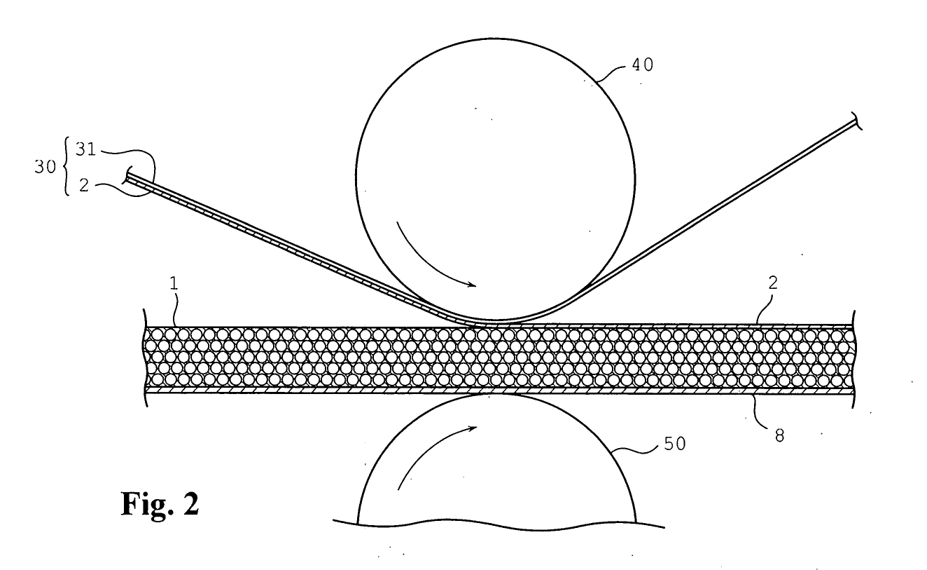

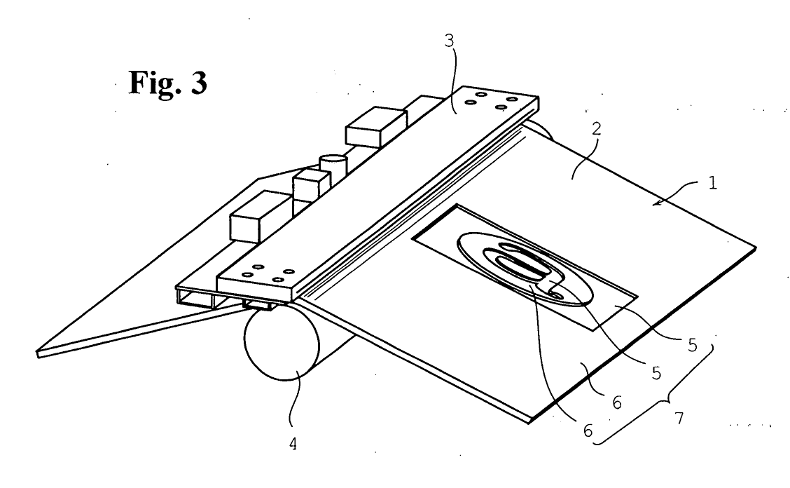

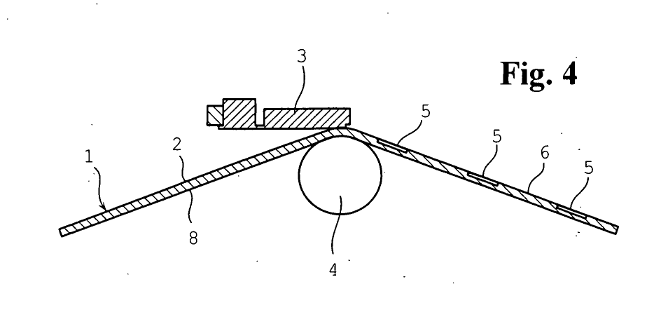

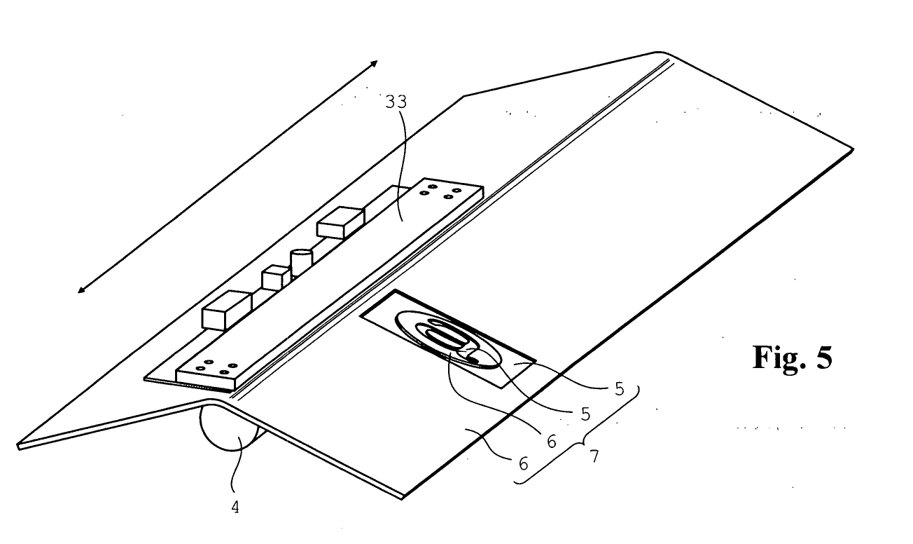

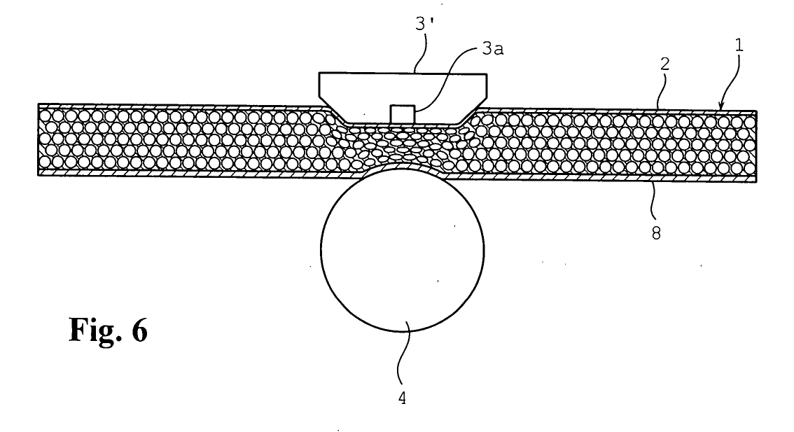

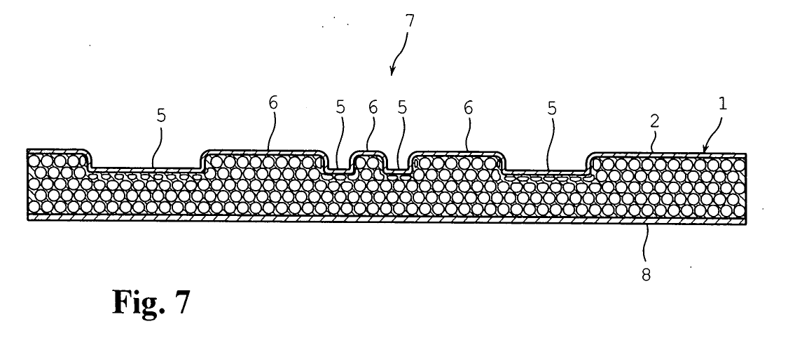

FIGS. 1 to 7 are views illustrating a method and an apparatus for manufacturing a printing plate according to a first embodiment, in which FIG. 1 is a cross-sectional view showing a porous sheet that is a material of a printing plate according to a first embodiment of the present invention, FIG. 2 is a view showing an example of a process of forming a coating layer on the porous sheet, FIG. 3 is a perspective view illustrating a method and an apparatus for manufacturing a printing plate according to the first embodiment, FIG. 4 is a cross-sectional view illustrating the method and the apparatus for manufacturing the printing plate according to the first embodiment, FIG. 5 is a perspective view illustrating a method and an apparatus for manufacturing a printing plate according to a modification, FIG. 6 is a cross-sectional view illustrating a method and an apparatus for a printing plate according to the modification, and FIG. 7 is a cross-sectional view showing a printing plate manufactured by the modification.

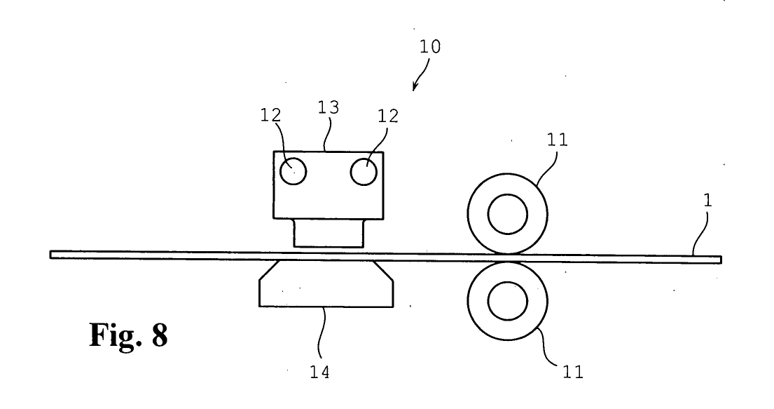

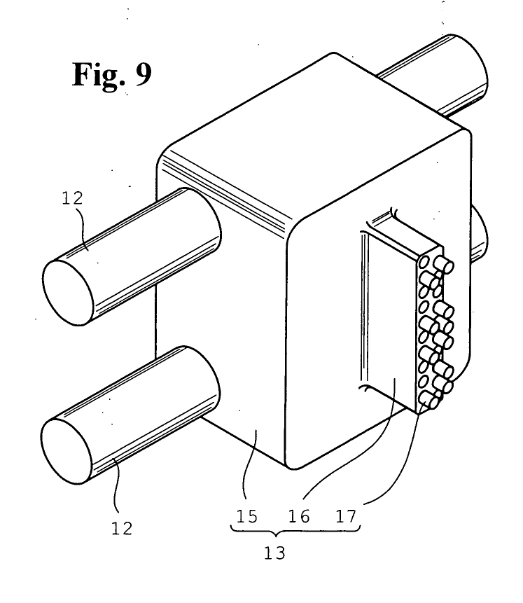

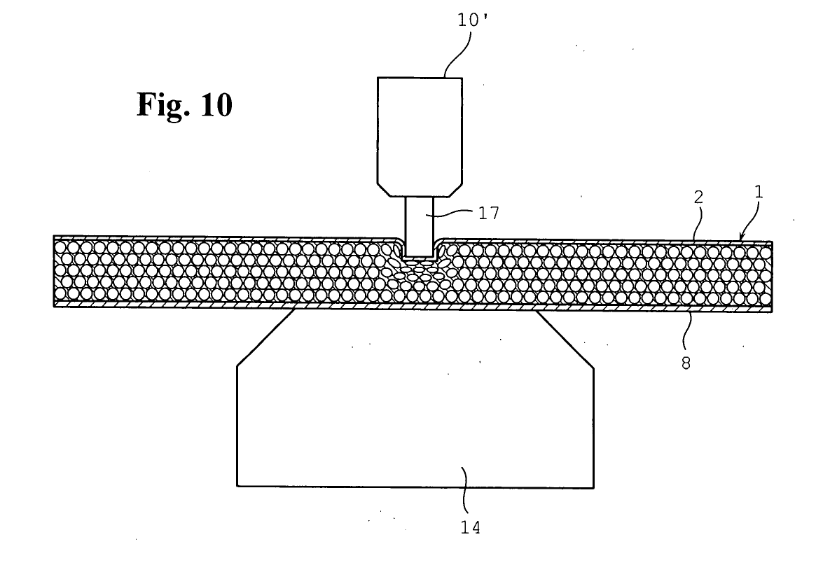

Further, FIGS. 8 to 10 are views illustrating a method and an apparatus for manufacturing a printing plate according to a second embodiment, in which FIG. 8 is a front view illustrating a method and an apparatus for manufacturing a printing plate according to a second embodiment, FIG. 9 is a perspective view showing the apparatus for manufacturing the printing plate according to the second embodiment, FIG. 10 is a cross-sectional view illustrating the method of manufacturing the printing plate according to the second embodiment.

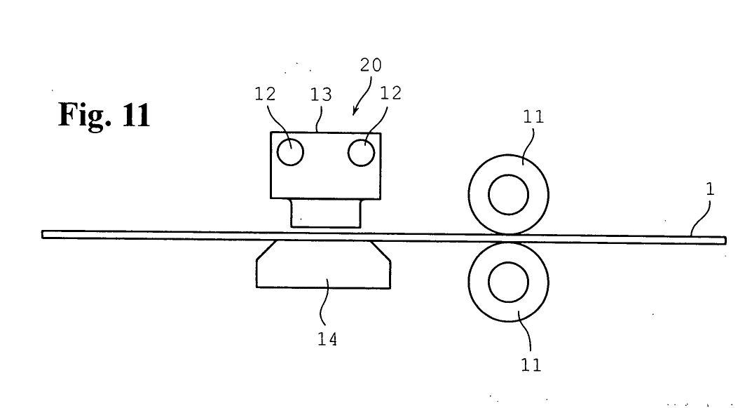

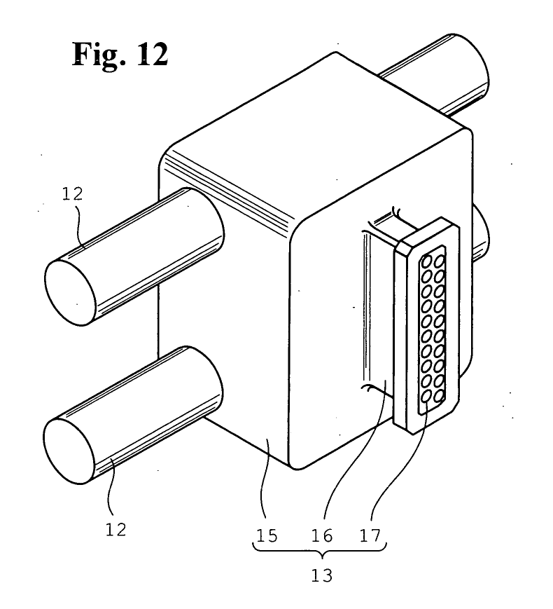

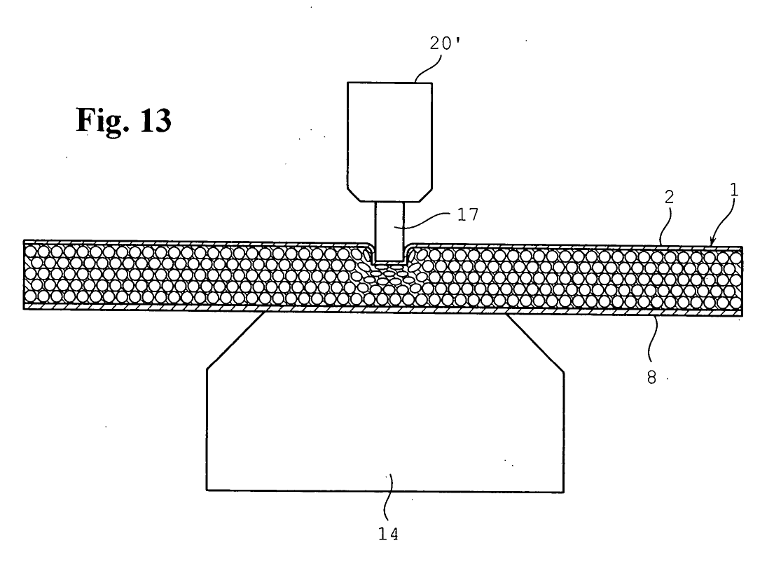

Further, FIGS. 11 to 13 are views illustrating a method and an apparatus for manufacturing a printing plate according to a third embodiment, in which FIG. 11 is a front view illustrating a method and an apparatus for manufacturing a printing plate according to a third embodiment, FIG. 12 is a perspective view showing the apparatus for manufacturing the printing plate according to the third embodiment, and FIG. 13 is a cross-sectional view illustrating the method of manufacturing the printing plate according to the third embodiment.

### 1. First Embodiment

### First Example, FIGS. 1 to 7, TPH Type

First, a printing plate according to a first example, a method and an apparatus for manufacturing the printing plate are described with reference to FIGS. 1 to 7.

(1) Manufacturing Process of Porous Sheet (Extraction Procedure)

FIG. 1 is a cross-sectional view schematically showing the structure of a porous sheet 1 that is used as a material of a printing plate of this example and the porous sheet 1 is first described.

The porous sheet 1 is a micro madreporite body formed in a sheet shape having-a microscopic three-dimensionally communicated foam structure. For manufacturing the porous sheet, various thermoplastic resins can be used and water having small environment load can be used for extracting a foam-forming material.

In detail, first, thermoplastic resin, water-soluble foam-forming material, and water-soluble polymer compound, which are raw materials, are mixed and kneaded by a predetermined device, and then the obtained mixture is formed in a sheet shape by an extruder, etc. A micro madreporite body having a three-dimensionally communicated foam structure (porous sheet 1 in this example) is achieved by extracting and removing the water-soluble foam-forming material and the water-soluble polymer compound by submerging the sheet body obtained as described above into water or warm water at a predetermined temperature, and providing plural microscopic foams.

As the thermoplastic resin, any resin that is dissolved by heating can be used, such as TPE (polyester-based, polyether-based, polyether polyester-based, styrene-based and polyamide-based, etc.), olefin resin (PE (LD-PE, HD-PE, LL-PE, alpha-olefin PE), PP, and TPO), TPU, polyamide, polyimide, or polyacetal, etc.

Further, as the water-soluble foam-forming material, any material, which is soluble and stable to heat even though the thermoplastic resin is dissolved by heat, is used. For example, as inorganic materials, NaCl, KC1, CaCl, NH₄Cl, NaNo₃, NaNo₂ etc. can be exemplified. As organic materials, TME-(trimethylolethane), trimethylolpropane, trimethylolbutane, cane sugar, water-soluble starch, sorbitol, glycine or sodium salt of each organic acid (malic acid, citric acid, glutamic acid, and succinic acid) can be exemplified.

Further, as the water-soluble polymer compound, any compound that is soluble and decreases viscosity with respect to resin can be used, such as polyethylene glycol derivatives etc., such as polyethylene glycol, poly ethylene glycol diacrylate, polyethylene glycol dioleate, and polyethylene glycol diacetate. In particular, since the polyethylene glycol has high melt flow and solubility, it can be appropriately used. Further, when an organic material is selected as the water-soluble foam-forming material, an action that promotes extracting and removing the water-soluble foam-forming material is known. In addition, when extrusion is applied, the molecular weight of the polyethylene glycol is in a range of 2,000 to 30,000, preferably 5,000 to 25,000, more preferably 15,000 to 25,000.

Further, for example, when olefin-based resin is used as the thermoplastic resin and polyethylene glycol having low compatibility with respect to the olefin-based resin is used as the water-soluble polymer compound, it is possible to control the grain diameter of the polyethylene glycol by using the low compatibility. That is, the water-soluble polymer compound that is a lubricant can be used as a water-soluble foam-forming material.

It is preferable that the mixture ratio of the thermoplastic resin, water-soluble foam-forming material, and the water-soluble polymer compound (water-soluble substance) is in a range of 10:90 to 40:60 vol %. When the thermoplastic resin is below 10 vol %, the compact itself is separated while the water-soluble substance is extracted and removed. On the other hand, when the water-soluble substance is over 60 vol %, sufficient number of foams are not formed in the compact.

It is preferable that the mixture ratio of the water-soluble foam-forming material constituting the water-soluble substance and the water-soluble polymer compound is in a range of 45:55 to 95:5 vol %. When the water-soluble foam-forming material is below 45 vol %, three-dimensionally communicated porous structure cannot be achieved, and when it is over 95 vol %, the extraction ratio of the water-soluble substance decreases, such that sufficient foam rate, that is, porosity is not obtained.

In particular, since it is preferable that the mixture ratio of the thermoplastic resin is in a range of 12 to 35 vol %, it is preferable that the mixture ratio of the water-soluble foam-forming material and the water-soluble polymer compound is in a range of 65:35 to 88:12 vol %.

When the mixture ratio of the thermoplastic resin, water-soluble foam-forming material, and water-soluble polymer compound is in the above-mentioned range, the water-soluble foam-forming material and the water-soluble polymer compound are easily and sufficiently extracted and removed by submerging the compact of the mixture in water, such that a micro madreporite body having a three-dimensionally communicated foam structure having uniformity and strength is achieved, which includes the thermoplastic resin as a main material. Further, by setting the mixture ratio of the thermoplastic resin, water-soluble foam-forming material, and water-soluble polymer compound within the above-mentioned preferable range, a micro madreporite body having a three-dimensionally communicated foam structure having a foam diameter of 500 μm or less and a foam rate of 75 to 85 vol % or more is achieved. Further, it is possible to manufacture a micro madreporite body having a foam rate of 30 μm or less by making the mixture ratio of the three ingredients more preferable.

For mixing and kneading the thermoplastic resin, water-soluble foam-forming material, and water-soluble polymer compound, a specific apparatus is not needed and the kneading speed is not limited. Temperature for the kneading is appropriately set according to the melting point of the thermoplastic resin-used. Preferably, the time for kneading is sufficient if the mixture is sufficiently mixed and kneaded, and generally 30 to 40 minutes are sufficient.

In the sheet body formed by mixing the ingredients, the water-soluble foam-forming material and the water-soluble polymer compound are extracted and removed by submerging them in water, which is a solvent, for a predetermined time (e.g. 24 to 48 hours, depending on the thickness, etc. of the sheet body). Further, in the submersion, it is preferable to extract and remove them by submersion that entirely contacts the sheet body to the water. The temperature of water used is not specifically limited and the room temperature may be possible, but it is preferable to use warm water at 15 to 60° C. to effectively remove the water-soluble substances.

According to this example, by using a water-soluble inorganic matter or an organic matter having high thermal stability as the foam-forming material, it is possible to achieve a porous sheet 1 having a three-dimensionally communicated foam structure that can be used at melting temperature of any thermoplastic resin and is not limited on the type of the thermoplastic resin. Further, plural thermoplastic resins may be mixed. Further, since an organic solvent, such as acetone, is not used for mixing the ingredients and extracting the water-soluble substances, it is possible to improve the working environment and considerably reduce the environment load.

(2) Process of Surface Treatment of Porous Sheet 1

The porous sheet 1 that is a micro madreporite body having a sheet shape having a three-dimensionally communicated foam structure is manufactured by the above materials and method, and then a process of surface treatment is applied to the porous sheet 1. The purpose of the process of surface treatment is to block plural holes formed inside on the surface of the porous sheet 1 and prevent ink from permeating inside when the ink is applied on the surface. The surface of the porous sheet 1 that is to be processed is a side where a printing image is formed.

The surface treatment of the process of the surface treatment in this example is to block the holes opened on the surface of the porous sheet 1 by forming a coating layer 2 on the surface of the porous sheet 1. As a method, it is possible to form the coating layer 2 by melting the surface of the porous sheet 1 using heat of TPH (Thermal Print Head) and closing the holes formed under the molten layer, using the molten resin. In this process, in order to form concavities and convexities of a desired printing image by the TPH, it is required to anti-fusion and high sliding property between the surface of the porous sheet 1 and the TPH, such that it is preferable to apply parting agent on the surface of the porous sheet 1. An ultraviolet cure silicon having a functional group is preferable as the parting agent. When the parting agent is used, it permeates to tens of micrometers in the holes opened on the surface of the porous sheet 1 and is solidified therein and the surface of the porous sheet becomes smooth, and all of the holes on the surface are closed and the ink cannot permeates inside. Further, when the concavities and convexities of a printing image are formed by the TPH, the sliding property between the TPH and the porous sheet 1 is good and it is possible to prevent fusion between the TPH and the porous sheet 1.

Further, a thin support body 8, such as a resin sheet or paper, which has high smoothness but does not have flexibility, is integrally formed on the other side opposite to the coating layer 2 of the porous sheet 1, in consideration of the operational performance of the porous sheet 1.

FIG. 2 shows another example of a method of surface treatment for forming the coating layer 2 on the surface of the porous sheet 1. According to this method, the porous sheet 1 without the coating layer 2 and a transferred object 30 for transferring the coating layer 2 to the porous sheet 1 are overlapped, this is interposed between a heat roller 40 and a backup roller 50, which are heat-transferring means, and carried while being heated and pressed, and the coating layer 2 is continuously thermally transferred to the porous sheet 1. The transferred object 30 is a sheet-shaped material formed by attaching the coating layer 2 of a thermoplastic material to the surface of a base 31 having good detachability.

As shown in FIG. 2, in this method, the porous sheet 1 and the transferred object 30 are formed in a continuous band. The transferred object 30 with the coating layer 2 down and the porous sheet 1 with the surface opposite to the support body layer 8 up are continuously provided between the heat roller 40 and the backup roller 50, which are rotating, by feeding mechanism (not shown). The transferred object 30 and the porous sheet 1 are overlapped and interposed between the rollers 40, 50. The transferred object 30 and the porous sheet 1 is heated and pressed by the rollers 40, 50 and carried to the opposite side while the coating layer 2 is in close contact with the surface of the porous sheet 1. Between the rollers 40, 50, the coating layer 2 is heated and melted by the heat roller 40, and separated from the base 31 and fused to the surface of the porous sheet 1 by being pressed between the heat roller 40 and the backup roller 50. The base 31 after the coating layer 2 is separated is detached from the porous sheet 1 and carried out, and returned to a return mechanism (not shown).

The material of the transferred object 30 is described hereafter.

As the base 31, polyester film, such as polyethylene terephthalate film and polyethylene naphthalate film, polycarbonate film, polyamide film, aramid film, and various plastic films that are generally used for a film for the base of an ink ribbon can be used. Further, high-density thin paper, such as condenser paper may be used. The thickness of the base 31 is preferably about 1 to 10 μm, more preferably 2 to 7 μm to improve thermal conduction and maintain the strength.

The thermoplastic material forming the coating layer 2 needs to be a thermoplastic material having a melting point lower than the melting point of the porous sheet in order to be thermally transferred without causing damage to the porous sheet. Resin can be used for the thermoplastic material that is suitable for the coating layer 2 that is suitable for the conditions. As for the resin, for example, one, or two or more components, including olefin-based copolymer resin, such as ethylene-acetic acid vinyl copolymer and ethylene-acrylic acid copolymer, polyamide-based resin, polyester-based resin, epoxy-based resin, polyurethane-based resin, acrylic resin, vinyl chloride resin, cellulose-based resin, vinyl alcohol-based resin, petroleum-based resin, phenol-based resin, styrene-based resin, vinyl acetate-based resin, elastomers, such as natural rubber, styrene butadiene rubber, isoprene rubber, and chloroprene rubber, and polyisobutylene and polybutene, can be exemplified.

Waxes can be used for the thermoplastic material for the coating layer 2. As the waxes, for example, natural waxes, such as paraffin wax, micro crystalline wax, Japan wax, bees wax, carnauba wax, and candelilla wax, synthetic waxes, such as polyethylene wax and Fischer-Tropsch wax, waxes, such as wax oxides or modified waxes of the natural waxes and synthetic waxes, higher fatty acid, such as myristic acid, palmitic acid, stearic acid, and behenic acid, other higher aliphatic alcohol, and wax-equivalent substances, such as higher fatty acid ester.

Further, mixture of resin and wax can be used for the thermoplastic material for the coating layer 2. Further, it is preferable that 5 μm is the upper limit on the thickness of the coating layer 2 of the transferred object 30.

As described above, according to the method illustrated in FIG. 2, it is possible to completely block the holes opened on the surface of the porous sheet 1, such that it is possible to form the stable thin coating layer having a thickness below 5 μm. When the porous sheet 1 having the stable thin coating layer 2 is plate-made by the TPH, which is described below, it is possible to minimize influence by the coating layer 2, such that it is possible to an image having deeper and clearer concavities and convexities. Further, by forming the coating layer 2 of a material having lower melting point that the melting point of the porous sheet 1, it is possible to make the temperature when the coating layer 2 is transferred lower than the melting point of the porous sheet 1, such that deformation due to heat does not appear on the surface of the porous sheet 1 and the processing tolerance of the porous sheet 1 is not reduced.

(3) Process of Forming Printing Image

Next, as show in FIGS. 3 and 4, a printing image 7 composed of concavities 5 and convexities 6 is formed on the porous sheet 1, where the surface treatment has been applied, by the TPH 3 (thermal print head) and the platen roller 4. The TPH 3 has plural dense heater elements densely arranged in a predetermined pattern, and is used for forming a plate-making image by applying heat sensitive boring to a master used for stencil printing to form an image on a heat sensitive paper. In this example, the porous sheet 1 is interposed between the TPH 3 and the platen roller 4, which are disposed adjacent, and the surface of the porous sheet 1 is fused by carrying the porous sheet 1 by driving the platen roller 4 and selectively driving the heater elements of the TPH 3 simultaneously with the carrying, such that the holes are collapsed and the concavities 5 are formed. The portions other than the concavities 5 formed by thermal fusion are the convexities 6, and the printing image 7 is entirely formed by the concavities 5 and the convexities 6.

As shown in FIGS. 3 and 4, the porous sheet 1 that has undergone surface treatment is interposed between the TPH 3 and the platen roller 4 and wrapped around the platen roller 4 at a small angle by applying tensile force to the porous sheet 1. Further, the porous sheet 1 is supported by the tensile force at both the front and rear portions of the THP 3 and the platen roller by a mechanism, which is not shown in the figures, and guided to move by driving the platen roller 4. Accordingly, the porous sheet 1 is carried while stably contacting with the TPH 3 and maintaining a predetermined wrapped angle around the platen roller 4. Further, since the surface where the printing image having the concavities and convexities of the porous sheet 1 is covered by the coating layer 2 formed of the parting agent, it smoothly slides with respect to the TPH 3. On the other hand, since the support body 8 is attached to the other surface of the porous sheet 1, such that the porous sheet can be smoothly carried by them.

Data of a desired printing image 7 is provided as a negative reflective data on the TPH 3. As the porous sheet 1 is carried, heat is applied to the surface of the porous sheet 1 by the TPH 3 driven on the basis of the data and the printing image 7 is formed. Since the porous sheet 1 has high porosity, it is fused and pressed while being heated by the TPH 3 and the platen roller 4, such that the portion is easily recessed and the concavities 5 are formed.

Since plural micro foams are continuously formed in the porous sheet 1, when the concavities 5 are formed by the heat, only the portions heated by the TPH 3 is fused inside and the holes are collapsed and become the concavities 5 by the heat. However, the shapes of the concavities 5 are different by the sizes of the foams in the porous sheet 1 and the interfaces of the concavities 5 and the convexities 6 are clear, such that when printing is performed by using the porous sheet 1 as a printing plate, it is possible to a clear printing image corresponding to the image of concavities and convexities.

Further, the delicate image composed of concavities and convexities can be achieved because the three-dimensionally communicated porous structure of the porous sheet 1 is formed by the extraction. That is, as described above, this is because the porous structure of the porous sheet 1 depends on the grain diameter of the water-soluble hole-forming material, which is extracted by water, such that it is easy to achieve a porous structure including plural foams having small and uniform size.

Further, as a common method of manufacturing a porous sheet, a foaming method of manufacturing a porous sheet by adding a foaming agent and a cross-linking agent for maintaining viscosity into a resin material has been known in the art, but fusion of the resin material by heat becomes difficult by adding the cross-linking agent. However, in this example, the above-mentioned extraction is used to manufacture the porous sheet 1 and a cross-linking agent is not added in the materials, such that it is possible to selectively and effectively heat-fuse only desired portions of the porous sheet by using heat of the THP 3 and it is possible to the form the printing image 7 using heat.

FIG. 5 illustrates when the porous sheet 1 is plate-made in a serial way by a relatively narrow TPH 33. That is, in plate-making using the TPH 3 illustrated with reference to FIGS. 3 and 4, it is possible to perform plate-making for the entire region throughout the width of the porous sheet 1 by using the wide TPH, but the wide TPH is not commonly used, such that the manufacturing cost increases. As shown in FIG. 5, although it is possible to reduce the cost of the plate-making apparatus by using the TPH 33 (about 300 nm width) of a stencil printing apparatus, there is a limit on the width in the plate-making. Therefore, as shown in FIG. 5, the TPH 33 is configured to be driven in a serial way. That is, the TPH 33 is disposed at a predetermined position in the sub-scanning direction that is parallel with the carrying direction of the porous sheet 1 and the TPH 33 can be moved in the main scanning direction at the position, which is shown by an arrow. Plate-making is performed throughout the entire width of the porous sheet 1 by moving the TPH 33 in the main scanning direction, the porous sheet 1 is moved at a predetermined distance in the sub-scanning direction, and the TPH 33 is moved again in the main scanning direction. Accordingly, it is possible to plate-make the sheet 1 that is wider than the TPH 33 by repeating the plate-making operation for the entire width of the porous sheet 1.

FIG. 6 shows a modification in which a TPH3′ having a different outer shape from FIGS. 3 and 4 is provided and a porous sheet 1 interposed between the platen roller 4 and the TPH 3′ is carried in a flat state, without being wound around the platen roller 4. As shown FIG. 6, while the portion that is pressed by between the TPH3′ and the platen roller 4 and heated by the heater elements 3a is pressure is applied and the holes are collapsed inside, such that as shown in FIG. 7, desired concavities 5 having desired sizes are formed at desired positions on the surface and the convexities 6, which is the counter parts, are formed at the other portions. Therefore, it is possible to form an entirely three-dimensional image 7 composed of the concavities 5 and the convexities 6.

(4) Process of Printing

The printing plate manufactured as described above is wounded around the outer circumference of a drum of a printing apparatus, ink is transferred on the surface of the convexities 6 of the printing plate by an inking roller, and the ink is retransferred on a provided printing medium and an image is printed by contacting the convexities 6 of the printing plate to the printing medium.

In this operation, the porous sheet 1 that is the material of the printing plate, as described above, has the three-dimensionally communicated holes structure to obtain an advantage of manufacturing a delicate plate-making image, but the coating layer 2 that is formed by coating the entire surface including the surfaces of the convexities 6 where the ink is applied, with the parting agent, such that the ink is prevented from permeating into the open-cell foam structure. Accordingly, it is possible to accurately control the amount of the ink on the surfaces of the convexities 6 while obtaining high quality in the printed image 7 on a printed matter obtained by transferring the ink.

In the first embodiment described above, although the printing image 7 is formed on the porous sheet 1 and wound around the drum of the printing apparatus, it is possible to form concavities and convexities of the printing image 7 on the porous sheet 1 by winding the porous sheet 1 around the drum, contacting the TPH3 to the surface of the porous sheet 1, and rotating the drum and simultaneously driving the TPH3.

In the first embodiment described above, although the printing image 7 is formed by forming the coating layer 2 on both surfaces of the porous sheet 1, it is possible to finish the surface treatment simultaneously with the process of forming an image by directly hang the porous sheet 1, before the coating layer 2 is formed, on the TPH3 and the platen roller 4, heating the surface of the portions that become the convexities 6 to be fused, simultaneously with forming the concavities 5 in the process of forming the printing image 7 by heating such that the holes on the surface of the convexities 6 are collapsed.

Further, it is possible to directly hang the porous sheet 1 before the coating layer 2 is formed on the TPH3 and the platen roller 4, finish forming the printing image 7 (forming the concavities 5) by heating, and then coat the holes of the surfaces of the convexities 6 with calcium carbonate powder mixed by a binder, and heat them to block the holes.

Further, it is possible to form a coating layer that blocks the holes on the surface of the porous sheet 1 by uniformly applying ultraviolet cure resin onto the surface of the porous sheet 1 and then hardening the resin by radiating ultraviolet rays.

### 2. Second Embodiment

### Second Example, FIGS. 8 to 10, Dot Impact Head Type

FIGS. 8 to 10 illustrate a printing plate according to the second embodiment, and method and apparatus for manufacturing the printing plate are described with reference to FIGS. 8 to 10.

In this example, concavities 5 are formed in desired shapes on the surface of a porous sheet 1 by an impact and the other portion than the collapsed concavities 5 become convexities 6, such that a printing image 7 is formed by the concavities 5 and the convexities 6 and a dot impact apparatus 10 is used to perform the method of manufacturing the printing plate. The dot impact apparatus 10 can be used as a printer that prints an image composed of groups of dots by hitting an ink ribbon on a paper with a pin or directly hitting an impact paper with a pin.

As shown in FIG. 8, a dot impact apparatus 10 includes two bar-shaped guide rails 12 disposed in parallel with each other in the horizontal direction perpendicular to the carrying direction of the porous sheet 1 carried by a pair of carrying rollers 11. A head 13 is movably guided on the guide rails 12. Further, a support 14 that supports a surface of the porous sheet 1 that absorb impact applied to the porous sheet 1 by the head 13 is disposed at a predetermined position opposite to the head 13 across the porous sheet 1.

As shown in FIG. 9, the head 13 of the dot impact apparatus 10 has a main body 15 where the guide rails 12 are inserted and that is moved while being guided by the guide rails 12 and a protrusion 16 that faces the porous sheet 1 from the main body 15. In the protrusion 16, plural pins 17 that have axes perpendicular to the surface of the porous sheet 1 are guided to protrude and draw back in. The pins 17 are selectively moved outward by a driving mechanism accommodated in the main body 15 and can form the concavities 5 by pressing the porous sheet 1 against the support 14 with predetermined force.

Further, the principle of the driving mechanism that drives the pins 17 is not limited, and for example, mechanism may be used which applies impact force to the porous sheet 1 by moving the pins using electromagnets that are selectively actuated, and pulling the pins 17 in the protrusion 16 using energizing force of return springs, when the electromagnets are not activated. Further, FIG. 7 shows the state where some of the plural pins 17 protrude outward in an arrangement in which the pins 17 in the main scanning direction are arranged in two rows in the sub-scanning direction.

In order to form a printing image 7 on the porous sheet 1 by using the apparatus, as the head 13 is appropriately moved on the guide rails 12 in the direction (main scanning direction) to perpendicular the carrying direction (sub-scanning direction) of the porous sheet 1, a desired image is formed throughout the entire positions in the main scanning direction, the porous sheet 1 is moved at a predetermined pitch by a carrying roller 11, the head 13 is appropriately moves on the guide rails 12 in the main scanning direction from the position, thereby forming a desired image at the entire positions in the main scanning direction. A desired image is formed on the front side of the porous sheet 1 in the same way.

In the dot impact apparatus 10, data of a desired printing image 7 is provided as a negative reflective data. An impact (pressing force) is applied to the surface of the porous sheet 1 by the dot impact apparatus 10 that is driven on the basis of the data while the porous sheet 1 is carried, such that the printing image 7 is formed. Since the porous sheet 1 has high porosity, as impact force is applied by the pins 17 of the dot impact apparatus 10, the corresponding portions become the concavities 5 while being easily pressed. As in the description for the first embodiment, unlike plate-making for flexography, according to this example, since the concavities 5 are simply formed by the impact force (pressing force), plate-making is simple. Also, only the portions pressed by the dot impact apparatus 10 become concavities. It is therefore possible to achieve an image composed of delicate concavities and convexities that is substantially the same as the data of the printing image 7.

FIG. 10 shows a modification using a dot impact apparatus 10′ having different pin arrangement and outer shape from FIGS. 8 and 9. As shown in FIG. 10, the portions of the porous sheet 1 where pressure is applied by the pin 17 protruding outward from the dot impact apparatus 10′ is pressed and the holes therein are collapsed. Accordingly, desired concavities 5 having desired sizes are formed at desired-positions on the surface and the other portions become the convexities 6, such that the printing image 7 that is consequently the same as the first embodiment shown in FIG. 7 is achieved.

### 3. Third Embodiment

### Third Example, FIGS. 11 to 13, Heating-Typed Dot Impact Head Type

A printing plate according to the third embodiment, method and apparatus for manufacturing the printing plate are described with reference to FIGS. 11 to 13.

In this example, concavities 5 having desired shapes are formed on the surface of a porous sheet 1 by impact (pressure) and heat, the portions fused and pressed by the heat become the concavities 5 and the other portions become convexities 6, such that a printing image 7 entirely composed of the concavities 5 and convexities 6 is formed. In order to perform the method of manufacturing the printing plate, a heated dot impact apparatus 20 is used, in which pins 17 are heated by heaters.

As shown in FIG. 11, a heated dot impact apparatus 20 includes two bar-shaped guide rails 12 disposed in parallel with each other in the horizontal direction perpendicular to the carrying direction of the porous sheet 1 carried by a pair of carrying rollers 11. A head 13 is movably guided on the guide rails 12. Further, a support 14 that supports a surface of the porous sheet 1 that absorb impact applied to the porous sheet 1 by the head 13 is disposed at a predetermined position opposite to the head 13 across the porous sheet 1.

As shown in FIG. 12, the head 13 of the heated dot impact apparatus 20 has a main body 15 where the guide rails 12 are inserted and that is moved while being guided by the guide rails 12 and a protrusion 16 that faces the porous sheet 1 from the main body 15. The plural pins 17 that have axes perpendicular to the surface of the porous sheet 1 are guided to protrude and be drawn. The pins 17 are heated by heating mechanism accommodated in the main body 15 and selectively moved outward by a driving mechanism accommodated in the main body 15, and can fuse the porous sheet 1 form the concavities 5 by pressing the porous sheet 1 against the support 14 with predetermined force, and effectively form the concavities 5 by pressing the porous sheet 1 with pressing force.

Further, the principle of the driving mechanism that drives and heats the pins 17 is not limited, and for example, mechanism may be used which moves the pins to hit the porous sheet 1 using electromagnets that are selectively actuated when the pins 17 are heated by electric heaters such that the pins are heated and apply impact force, pulling the pins 17 into the protrusion 16 using energizing force of return spring when the electromagnets are not activated. FIG. 12 shows when some pins 17 in the pins are pushed outward, in a pin arrangement in which the pins 17 arranged in a row in the main scanning direction is arranged in two rows in the sub-scanning direction.

In order to form a printing image 7 on the porous sheet 1 by using the apparatus, as the head 13 is appropriately moved on the guide rails 12 in the direction (main scanning direction) to perpendicular the carrying direction (sub-scanning direction) of the porous sheet 1, a desired image is formed throughout the entire positions in the main scanning direction, the porous sheet 1 is moved at a predetermined pitch by a carrying roller 11, the head 13 is appropriately moves on the guide rails 12 in the main scanning direction from the position, thereby forming a desired image at the entire positions in the main scanning direction. A desired image is formed on the front side of the porous sheet 1 in the same way.

In the heated dot impact apparatus 20, data of a desired printing image 7 is provided as a negative reflective data. Heat and impact (pressing force) are simultaneously applied to the surface of the porous sheet 1 by the heated dot impact apparatus 20 that is driven on the basis of the data while the porous sheet 1 is carried, such that the printing image 7 is formed. Since the porous sheet 1 has high porosity, as heat and impact force are simultaneously applied by the pins 17 of the heated dot impact apparatus 20, the corresponding portions become the concavities 5 while being easily fused and pressed. As in the description for the first embodiment, unlike plate-making for flexography, according to this example, since the concavities 5 are easily and simply formed by the raising effect of the heat and impact force (pressing force), plate-making is simple and, since only the pressed portions by the heated dot impact apparatus 20 are pressed, it is possible to achieve an image composed of delicate concavities and convexities that is substantially the same as the data of the printing image 7.

FIG. 13 shows a modification using the heated dot impact apparatus 20, which has different pin arrangement and outer shape from FIGS. 11 and 12. As shown in FIG. 13, portions where heat and pressure are applied by pins 17 that are heated and protrude outward from the heated dot impact apparatus 20 are fused and pressed, and collapsed. Accordingly, concavities 5 having desired sizes are formed at desired positions on the surface and the other portions become convexities 6, such that the printing image 7 that is consequently the same as the first embodiment shown in FIG. 7 is achieved.

However, according to this example, both heat and pressure are simultaneously used to form corresponding concavities and convexities on the porous sheet 1 and the heated pins 17 are pressed into the porous sheet 1, such that the resin of the porous sheet 1 is fused and pressed, thereby forming the concavities 5. Therefore, the interfaces of the concavities and the convexities become clear and the clearness of the printing image 7 can be achieved as compared with the first embodiment that forms the concavities only by contacting and heating the porous sheet 1 to the flat surface of the TPH3 using the heater elements.

What is claimed is:

1. A printing plate that has a printing image, which has concavities and convexities, on a surface, and performs printing by transferring ink applied to printing surfaces of the convexities onto a printing medium,
wherein a printing image having concavities and convexities is formed on a surface of a porous sheet having three-dimensionally communicated holes, and at least holes of printing surfaces of the convexities are blocked.

2. The printing plate according to claim 1, wherein the porous sheet is manufactured by extracting and removing water-soluble hole-forming material and water-soluble polymer compound using water from a formed body of a mixture that is obtained by heating-mixing non-water-soluble thermoplastic resin, water-soluble hole-forming material that is thermally stable at temperature where the thermoplastic resin is melted, and water-soluble polymer compound functions as a lubricant, and the holes of the printing surfaces of the convexities are blocked by a coating layer formed on the printing surfaces.

3. A method of manufacturing a printing plate that has a printing image, which has concavities and convexities, on a surface, and performs printing by transferring ink applied to printing surfaces of the convexities onto a printing medium, the method comprising:
a process of blocking holes formed on a surface of a porous sheet having three-dimensionally communicated holes by forming a coating layer on the surface of the porous sheet; and
a process of forming a printing image having convexities and concavities, on the porous sheet, by using at least one operation selected from among operations of heating and impact.

4. A method of manufacturing a printing plate that has a printing image, which has concavities and convexities, on a surface, and performs printing by transferring ink applied to printing surfaces of the convexities onto a printing medium, the method comprising:
a process of forming a printing image having convexities and concavities, on a surface of a porous sheet having three-dimensionally communicated holes, by using at least one operation selected from among operations of heating and impact; and
a process of surface treatment that blocks at least holes of printing surfaces of the convexities of the porous sheet.

5. A method of manufacturing a printing plate that has a printing image, which has concavities and convexities, on a surface, and performs printing by transferring ink applied to printing surfaces of the convexities onto a printing medium,
wherein a printing image having convexities and concavities on a surface of a porous sheet having three-dimensionally communicated holes is formed by heating, and at least holes of the printing surfaces of the convexities are blocked.

6. An apparatus for manufacturing a printing plate that has a printing image, which has concavities and convexities, on a surface, and performs printing by transferring ink applied to printing surfaces of the convexities onto a printing medium, the apparatus comprising image forming means for form a printing image having convexities and concavities, on a surface of a porous sheet having three-dimensionally communicated holes, by using at least one operation selected from among operations of heating and impact.

7. A printing method that performs printing by transferring, onto a printing medium, ink applied to printing surfaces of convexities of a printing image having the convexities and concavities, wherein by applying a predetermined amount of ink to the printing surface where holes of the convexities, which are formed on a surface of a porous sheet having three-dimensionally communicated holes, are blocked, and bringing the printing surfaces of the convexities into contact with the printing medium, the ink is transferred to the printing medium and the image is formed on the printing medium by the ink.
